(19) United States
(12) Patent Application Publication
(10) Pub. No.: US 2013/0335324 A1
(43) Pub. Date: Dec. 19, 2013

(54) COMPUTER VISION BASED TWO HAND CONTROL OF CONTENT

(71) Applicant: POINTGRAB LTD., Hod Hasharon (IL)

(72) Inventors: Amir KAPLAN, Hod-HaSharon (IL); Eran Eilat, Givatayim (IL); Haim Perski, Hod-HaSharon (IL)

(73) Assignee: POINTGRAB LTD., Hod Hasharon (IL)

(21) Appl. No.: 13/969,654

(22) Filed: Aug. 19, 2013

Related U.S. Application Data
(63) Continuation of application No. 13/977,965, filed on Jul. 2, 2013.
(60) Provisional application No. 61/430,373, filed on Jan. 6, 2011.

(51) Int. Cl. G06F 3/01

(52) U.S. Cl. CPC G06F 3/011
USPC 345/158

(57) ABSTRACT

A system and method for manipulating displayed content based on computer vision by using a specific hand posture. In one embodiment a mode is enabled in which content can be manipulated in a typically two handed manipulation (such as zoom and rotate).

### CROSS-REFERENCE TO RELATED APPLICATIONS

This application is a continuation of U.S. patent application Ser. No. 13/977,965, filed on Jul. 2, 2013, which is a National Phase Application of PCT International Application No. PCT/IL2012/000007, filed on Jan. 5, 2012, claiming the benefit of U.S. Provisional Application No. 61/430,373, filed on Jan. 6, 2011, which are hereby incorporated by reference.

### FIELD OF THE INVENTION

The present invention relates to the field of posture and gesture based control of electronic devices. Specifically, the invention relates to computer vision based hand posture and gesture recognition.

### BACKGROUND OF THE INVENTION

The need for more convenient, intuitive and portable input devices increases, as computers and other electronic devices become more prevalent in our everyday life. A pointing device is one type of input device that is commonly used for interaction with computers and other electronic devices that are associated with electronic displays. Known pointing devices and machine controlling mechanisms include an electronic mouse, a trackball, a pointing stick and touchpad, a touch screen and others. Known pointing devices are used to control a location and/or movement of a cursor displayed on the associated electronic display. Pointing devices may also convey commands, e.g. location specific commands, by activating switches on the pointing device.

In some instances there is a need to control electronic devices from a distance, in which case the user cannot touch the device. Some examples of these instances include watching TV, watching video on a PC, etc. One solution used in these cases is a remote control device.

Recently, human gesturing, such as hand gesturing, has been suggested as a user interface input tool, which can be used even at a distance from the controlled device. Typically, a hand posture or gesture is detected by a camera and is translated into a specific command.

Manipulation of displayed content, such as zooming in/out, is also possible by computer vision based hand gesturing. Typically, movement of hands causes movement, rotation or zooming in/out of content on a screen. However, in order to stop manipulation and to generate other commands the user must move his hands out of the camera field of view and then bring them in to the field of view again. Thus, currently known methods of manipulation do not provide a full solution which enables a user to freely manipulate displayed content.

### SUMMARY OF THE INVENTION

Embodiments of the invention provide a system and method for easily controlling a device based on hand postures and gestures, which enable a user to smoothly and intuitively alternate between different commands.

In one embodiment the system and method include manipulating displayed content by using a specific hand posture (“manipulation posture”). In one embodiment a mode (“manipulation mode”) is enabled in which content can be manipulated in a typically two handed manipulation (such as zoom and rotate) by using the manipulation posture.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a system operable according to embodiments of the invention;

FIG. 2 schematically illustrates a method for computer vision based two hands control of displayed content, according to one embodiment;

FIG. 3 schematically illustrates a method for computer vision based two hands control of a cursor, according to one embodiment of the invention;

FIGS. 4A-D schematically illustrate several embodiments of a device that can be controlled based on computer vision identification of hand postures and gestures;

FIGS. 5A-B schematically illustrate a device and GUI according to two embodiments of the invention;

FIG. 6 schematically illustrates a device and GUI according to another embodiment of the invention;

FIG. 7 schematically illustrates a method for controlling a graphical element on a GUI, according to an embodiment of the invention; and

FIG. 8 schematically illustrates a method for computer vision based control of a device, according to an embodiment of the invention.

### DETAILED DESCRIPTION OF THE INVENTION

According to an embodiment of the invention a system for user-device interaction is provided which includes a device having a display and an image sensor which is in communication with the device and with a processor. The image sensor obtains image data and sends it to the processor to perform image analysis to detect and track a user's hand from the image data and to detect postures of the user's hand to control the device, typically to control displayed content.

According to embodiments of the invention detection of a particular hand posture or gesture or the detection of two hands (rather than a single hand) causes the system to interpret hand gestures as a command to manipulate displayed content according to the user's hand(s) movement, (in some embodiments to select displayed content and to track the user's hand to manipulate the selected content according to the user hand movement). Selection of visually displayed content or of a graphical element on a GUI enables the user to manipulate the displayed content or graphical element, such as to move the content or element, to stretch images or parts of images, to zoom in or out a screen or part of a screen, to rotate selected content etc.

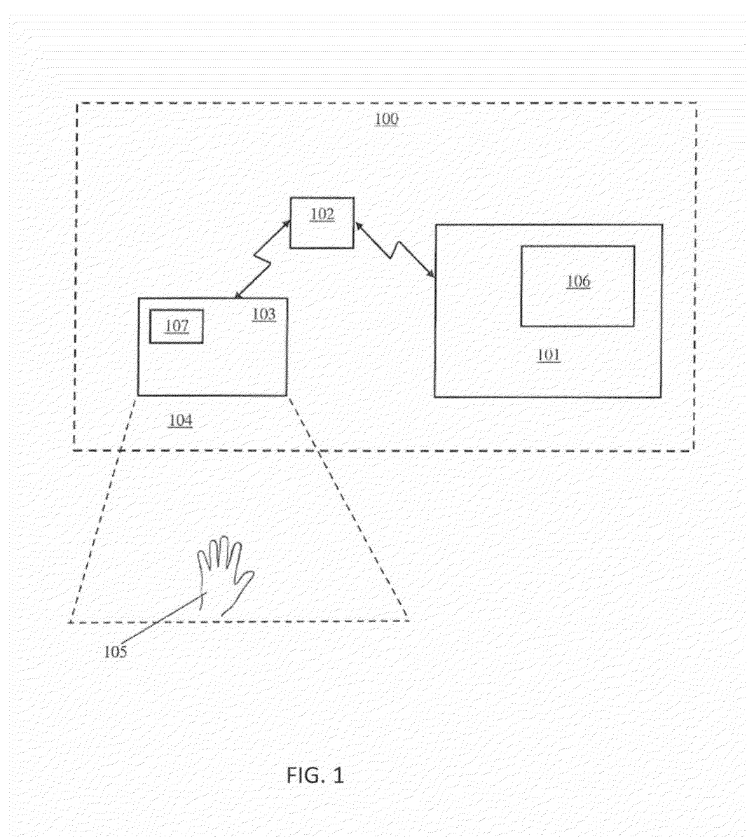

Reference is now made to FIG. 1 which schematically illustrates a system 100 according to an embodiment of the invention. The system 100 includes an image sensor 103 for obtaining images of a field of view (FOV) 104. The image sensor 103 is typically associated with a processor 102, and optionally with a storage device 107 for storing image data. The storage device 107 may be integrated within the image sensor 103 or may be external to the image sensor 103. According to some embodiments image data may be stored in the processor 102, for example in a cache memory.

Image data of the field view (FOV) 104 is sent to the processor 102 for analysis. A user hand 105, within the field of view 104, is detected and tracked and a posture or gesture of the hand may be identified by the processor 102, based on the image analysis. According to some embodiments more than one processor may be used by the system 100.

A device 101 is in communication with the processor 102. The device 101 may be any electronic device that has or that is connected to an electronic display 106 optionally having a graphic user interface (GUI), e.g., TV, DVD player, PC, mobile phone, camera, STB (Set Top Box), streamer, etc. According to one embodiment, device 101 is an electronic device available with an integrated standard 2D camera. According to other embodiments a camera is an external accessory to the device. According to some embodiments more than one 2D camera are provided to enable obtaining 3D information. According to some embodiments the system includes a 3D camera.

The processor 102 may be integral to the image sensor 103 or may be a separate unit. Alternatively, the processor 102 may be integrated within the device 101. According to other embodiments a first processor may be integrated within the image sensor 103 and a second processor may be integrated within the device 101.

The communication between the image sensor 103 and the processor 102 and/or between the processor 102 and the device 101 may be through a wired or wireless link, such as through IR communication, radio transmission, Bluetooth technology and other suitable communication routes and protocols.

According to one embodiment the image sensor 103 is a forward facing camera. The image sensor 103 may be a standard 2D camera such as a webcam or other standard video capture device, typically installed on PCs or other electronic devices. According to some embodiments, the image sensor 103 can be IR sensitive.

The processor 102 can apply image analysis algorithms, such as motion detection and shape recognition algorithms to identify and further track the user's hand 105.

According to some embodiments the electronic display 106 may be a separate unit from the device 101.

The system 100 may be operable according to methods, some embodiments of which are described below.

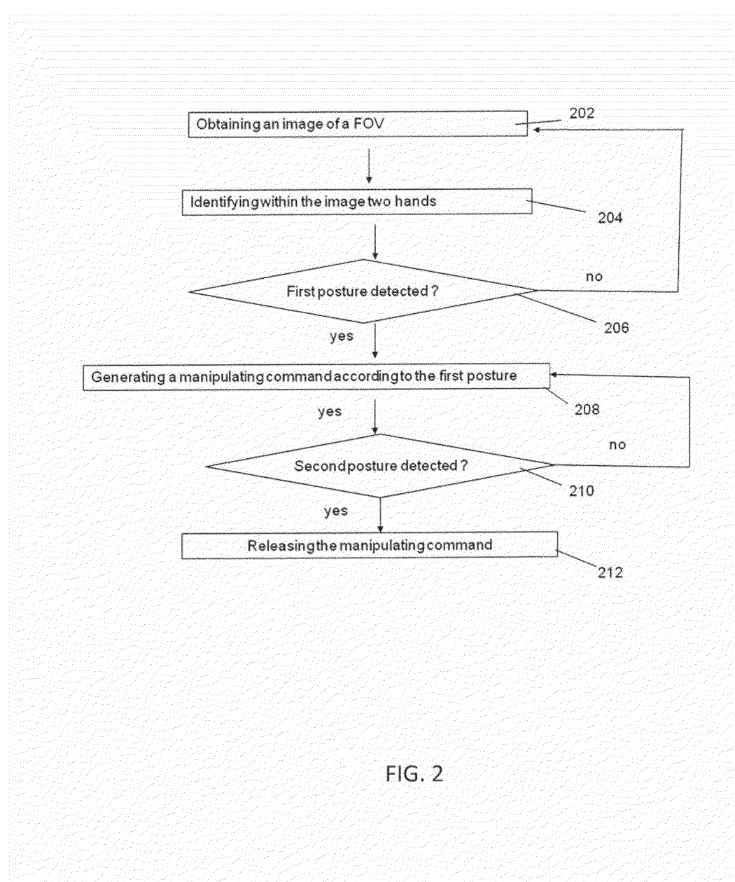

A method for computer vision based two hands control of displayed content, according to one embodiment is schematically illustrated in FIG. 2. An image or series of images of a field of view are obtained (202) and two hands are identified within at least one of the images (204), for example, by a processor (e.g., 102) applying shape recognition algorithms. A posture of at least one of the hands is detected, e.g., by comparing the shape of the detected hand to a library of hand posture models. If the detected posture corresponds to a specific pre-defined posture (206) (e.g., a manipulation posture), a command is generated to manipulate the displayed content, e.g. on display 106, according to the predefined posture (208).

According to one embodiment, the presence of a second hand in the field of view enables a “manipulation mode”. Thus, according to one embodiment, a pre-defined hand posture (manipulation posture) enables specific manipulation of displayed content, only when two hands are present. For example, when a manipulation posture is performed in the presence of a single hand content or a graphical element may be dragged following the single user's hand movement but in response to the appearance of a second hand, performing the manipulation posture may cause manipulations such as rotating, zooming or otherwise manipulating the content based on the user's two hands movements.

According to some embodiments an icon or symbol correlating to the position of the user's hands may be displayed such that the user can, by moving his/her hands, navigate the symbol to a desired location on a display to manipulate content that is displayed at that location.

According to one embodiment displayed content may be manipulated based on the position of the two detected hands. According to some embodiments the content is manipulated based on the relative position of one hand compared to the other hand. Manipulation of content may include, for example, moving selected content, zooming, rotating, stretching or a combination of such manipulations. For example, when performing the manipulating posture, in the presence of two hands, the user may move both hands apart to stretch or zoom out the image. The stretching or zooming would typically be proportionate to the distance of the hands from each other.

Content may be continuously manipulated as long as a first posture is detected. To release the manipulation of the content a second posture of at least one of the two hands is detected (210); and based on the detection of the second posture the manipulation command is disabled and the displayed content is released of manipulation (212). Thus, for example, once the user has stretched the image to its desired proportions the user may change the posture of one or two of his/her hands to a second, pre-defined “release manipulation posture” and the content will not be manipulated further even if the user moves his/her hands.

According to one embodiment a manipulation posture includes a hand with the tips of all fingers brought together such that the tips touch or almost touch each other. According to one embodiment the manipulation posture is used to select content and/or to manipulate selected content, e.g., dragging the content.

Identifying a hand and/or identifying a posture may be done using known methods, for example, by applying shape and/or contour detection algorithms. According to one embodiment a contour detector may be applied on images of the field of view to find contour features of an imaged object (typically, the user's hand). Contour features of the object may be compared to a contour model of a hand to obtain a vector of comparison grades and a machine learning algorithm may be applied to obtain a vector of numerical weights, from which a final grade is calculated. If the final grade is above a predetermined threshold the object is identified as a hand and if the final grade is below the predetermined threshold additional images are then processed.

According to one embodiment both an object and a contour model of a hand can be represented as sets of features, each feature being a set of oriented edge pixels. A contour model of a hand may be created by obtaining features of model hands, which is a collection of multiple hands used to generate a model of a hand; randomly perturbing the features of the model hand; aligning the features and selecting the most differencing features out of the features of the model hand (e.g., selecting 100 most differencing features out of 1000 features), using machine learning techniques, to generate a contour model of a hand. Comparison of the object to the contour model may be done, for example, by matching edge maps of the object and model (e.g., oriented chamfered matching). The matching may include applying a distance function. For example, a point on the contour of the object from within a region of interest may be compared to a centered model to obtain the distance between the two and an average distance may be calculated by averaging all the measured distances. If the distance is lower than the threshold calculated for that feature, the weight of that feature is added to the total rank of the matching. If the total rank is above a certain threshold, the object is identified as a hand.

According to some embodiments a posture may be identified as a “manipulation posture” only if the system is in “manipulation mode”. A specific gesture, posture or other signal may need to be identified to initiate the manipulation mode. For example, a posture may be identified as a “manipulation posture” and content may be manipulated based on this posture only if two hands are detected.

Some embodiments are meant to raise the probability that both hands belong to a single user. According to one embodiment, the two hands must be identified as a left hand and a right hand. According to another embodiment the two hands detected must be in approximately the same size. According to yet another embodiment the method may include detecting a face; and if the face is positioned in between the left hand and right hand then based on the detection of the pre-defined posture, selecting displayed content and manipulating the displayed content.

In one embodiment, “manipulation mode” is initiated by detection of an initialization gesture, such as, a pre-defined motion of one hand in relation to the other, for example, moving one hand closer or further from the other hand. According to some embodiments an initializing gesture includes two hands having fingers spread out, palms facing forward. In another embodiment, specific applications may be a signal for the enablement of “manipulation mode”. For example, bringing up map based service applications (or another application in which manipulation of displayed content can be significantly used) may enable specific postures to generate a command to manipulate displayed maps.

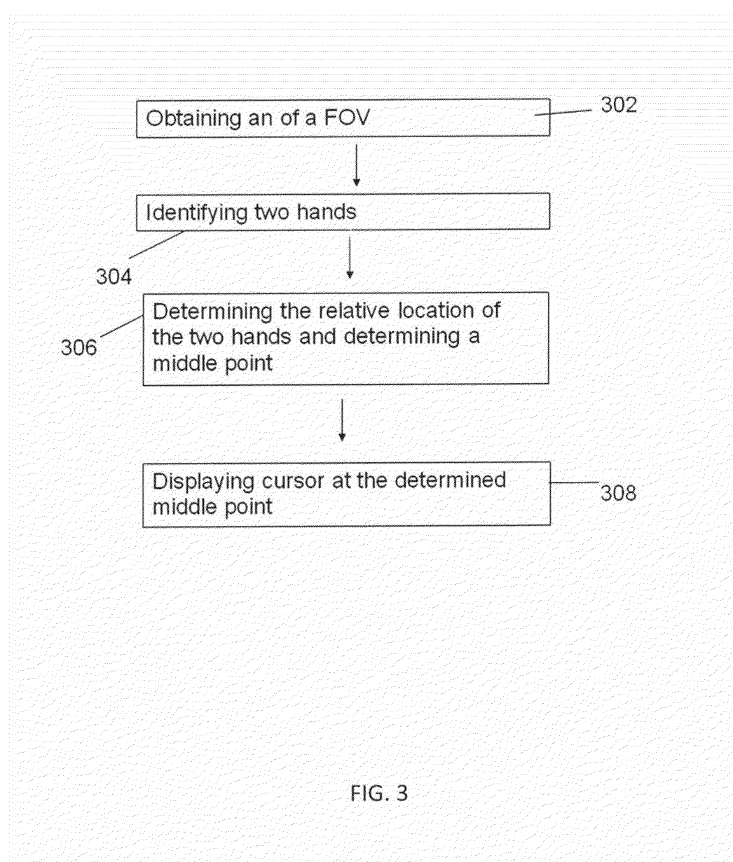

Embodiments of the invention also provide a method for computer vision based two hands control of a cursor or other icon, symbol or displayed content. According to one embodiment, schematically illustrated in FIG. 3, the method includes obtaining an image of a field of view (302); identifying within the image two hands (304); determining the relative location of the two hands to each other and determining the middle point between the two hands (306) and displaying a cursor (for example) at the determined middle point (308). According to one embodiment detection of two hands may generate a command to select the cursor. Once a cursor is displayed and selected movement of one or both hands may move the cursor. Specific postures of one or two hands may command specific manipulation of the cursor.

According to some embodiments the cursor may be displayed at a different predetermined point in between the two hands, not necessarily the middle point.

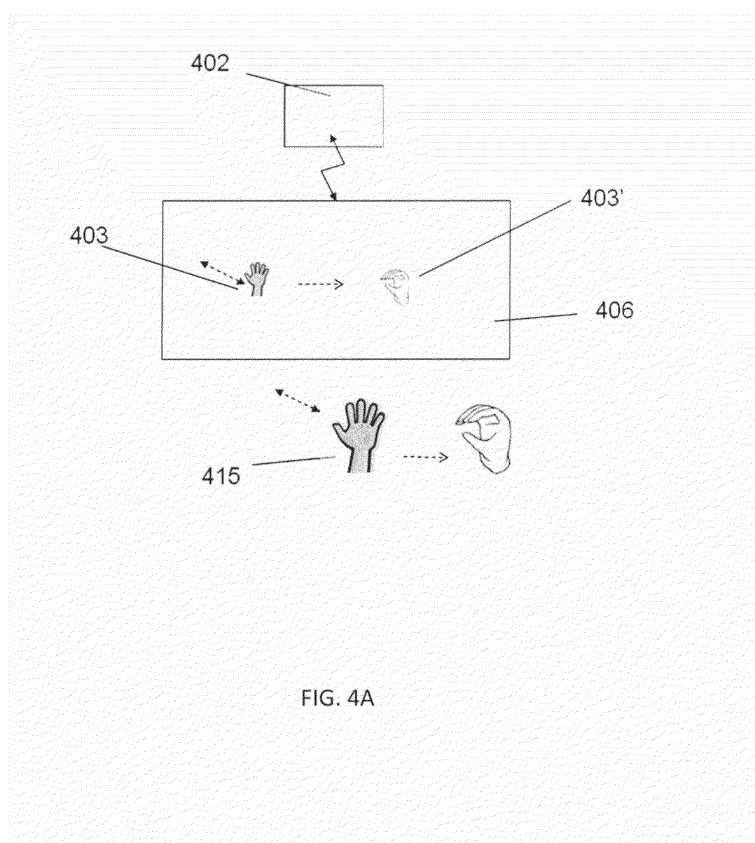

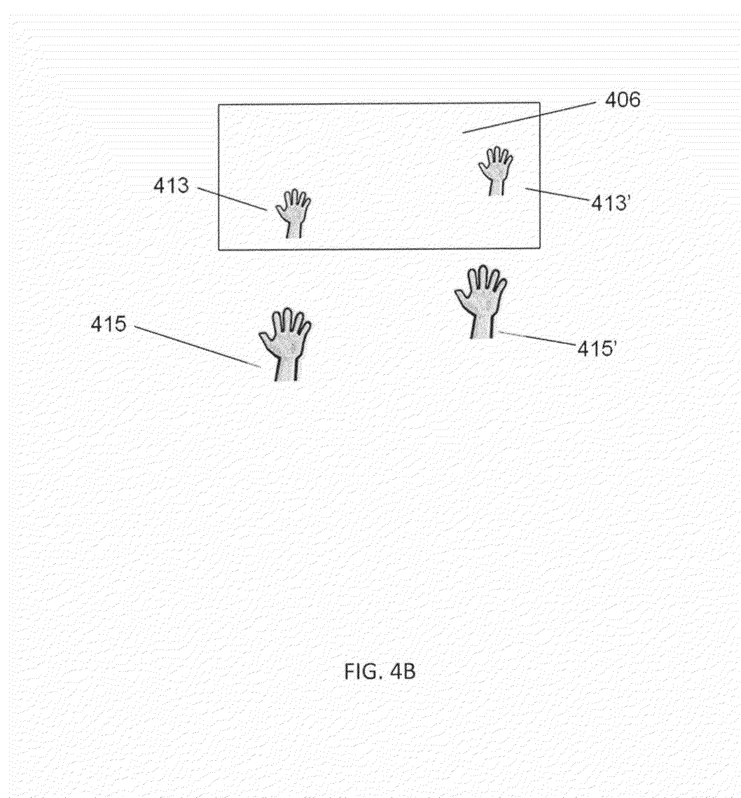

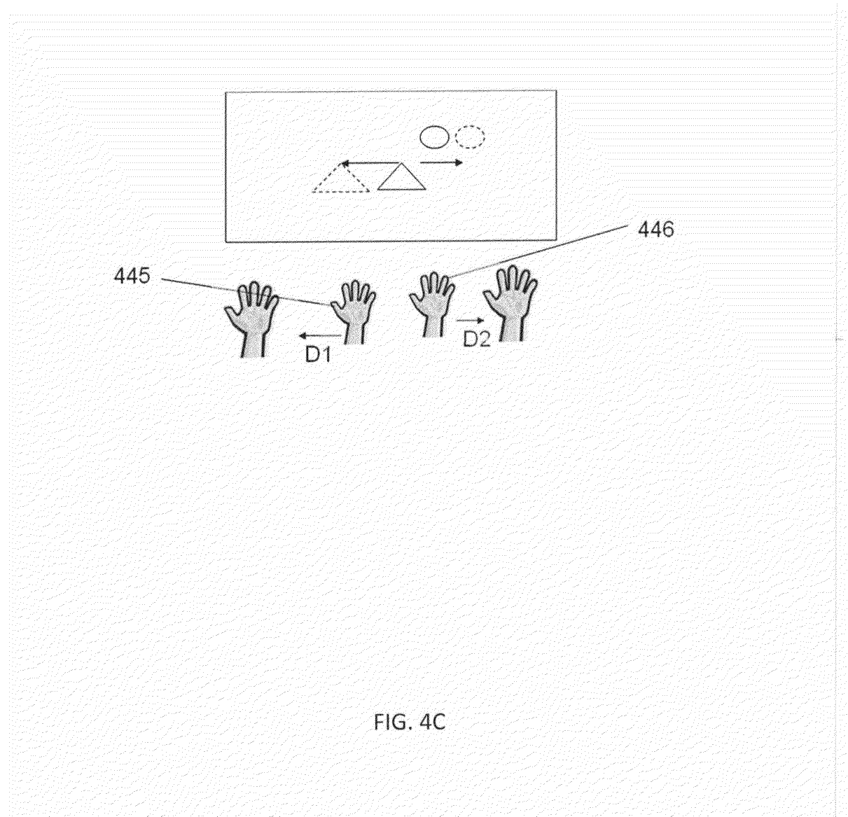

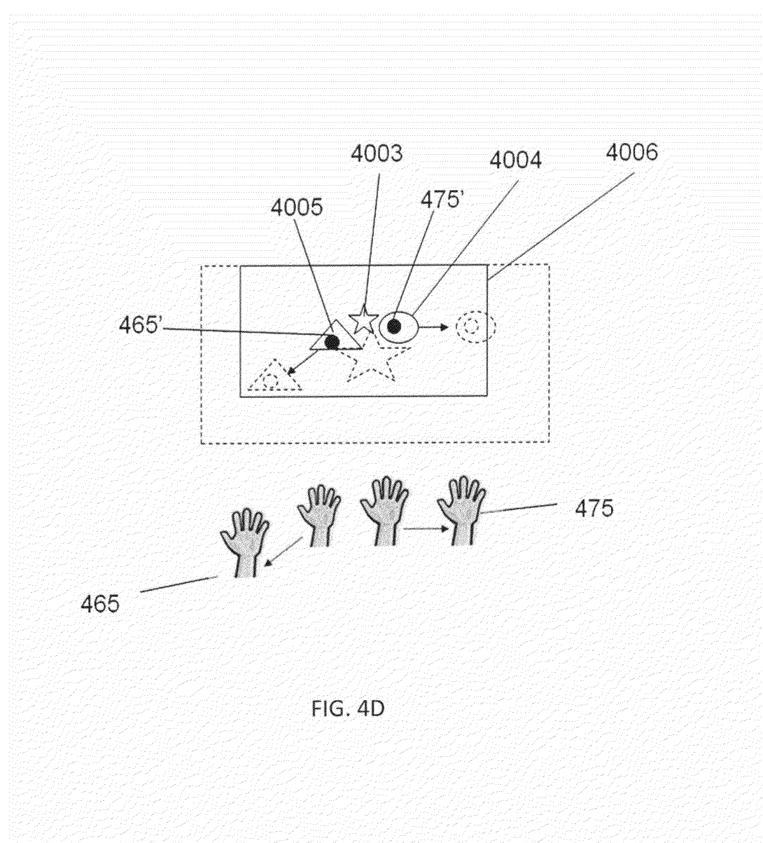

According to one embodiment of the invention there is provided a device that can be controlled based on computer vision identification of hand postures and gestures. According to an embodiment which is schematically illustrated in FIG. 4A, there is provided a device having a processor 402 and a display 406, the display having graphical user interface (GUI).

The processor 402 is in communication with an image sensor (such as image sensor 103) to obtain images and the processor 402, or another processing unit, can detect and track a user's hand 415 from the images.

Tracking a user's hand may be done by known tracking methods. For example, tracking may include selecting clusters of pixels having similar movement and location characteristics in two, typically consecutive images. A hand shape may be detected (e.g., as described above) and points (pixels) of interest may be selected from within the detected hand shape area, the selection being based, among other parameters, on variance (points having high variance are usually preferred). Movement of points may be determined by tracking the points from frame n to frame n+1. The reverse optical flow of the points may be calculated (the theoretical displacement of each point from fame n+1 to frame n) and this calculation may be used to filter out irrelevant points. A group of points having similar movement and location parameters is defined and these points are used for tracking

According to one embodiment a symbol 403 is displayed on the display 406, the symbol correlating to the user's hand. The symbol 403 may be an icon of a hand or any other graphical element. The symbol 403 typically moves on the display 406 according to movement of the imaged user hand movement.

By applying shape detection algorithms or other appropriate algorithms the processor 402 or other processing unit may detect a pre-defined posture of the user's hand and based on the detection of the pre-defined posture the symbol 403 is changed on the GUI to another symbol 403′. According to one embodiment the pre-defined posture resembles a “grab” posture of the hand (hand having the tips of all fingers brought together such that the tips touch or almost touch each other) and symbol 403′ is a “grab symbol”, for example, an icon of a hand having the tips of all fingers brought together such that the tips touch or almost touch each other.

The symbol 403′ may be changed back to symbol 403 based on the detection of a second posture (Typically, a “release manipulation posture”) for example, a palm facing the camera with all fingers extended.

According to another embodiment, which is schematically illustrated in FIG. 4B, the processor 402 may identify two hands 415 and 415′ and the GUI may include a first symbol 413 representing the first hand 415 and a second symbol 413′ representing the second hand 415′. The symbols 413 and 413′ may be relatively positioned on the display 406 in proportion to the relative position of the user's first hand 415 and the user's second hand 415′. The symbol 413 can move on the display 406 according to movement of the user's first hand 415 and the second symbol 413′ can move on the display 406 according to movement of the user's second hand 415′. The user's first hand 415 may be identified by the processor 402 as a right hand and the user's second hand 415′ may be identified by the processor 402 as a left hand or vice versa.

Left and right hand identification may be based on edge detection and feature extraction. For example, a potential hand area may be identified and compared to a left and/or right hand, hand model.

According to one embodiment content displayed in the vicinity of the symbol 403 or 413 or 413′may be selected and manipulated based on movement of the symbol 403, 413 and/or 413′. Manipulating can include moving, zooming, rotating, stretching or other manipulations of visual content.

According to one embodiment movement of the hands, or relative movement of the hands, is normalized to the size of the hand, rather than directly to the number of pixels being moved in an image. For example, movement of two “hand sizes” may stretch an object by twofold. This way a user may move his hands apart or closer, the distance of the movement being independent of the distance of the user's hands from the image sensor or from the display.

Manipulating content based on moving a symbol (such as symbols 413 and 413′) may enable flexible manipulation based on the location of the symbol within the content, as opposed to the more rigid manipulation which is based on hand gesturing. For example, as schematically illustrated in FIG. 4C, in a case where an image is displayed, once a “manipulation mode” is enabled (for example, by the presence of two hands 445 and 446) a user may perform a posture which enables manipulation of the image, for example, stretching of the image (zooming out). Movement of one or two of the user's hands by distance D1 and D2 will stretch the image proportionally according to the distance moved by the user's hand(s) (in the figure, the objects drawn with solid lines are located, after stretching of the image, where the objects with dashed lines are drawn.). In the case schematically illustrated in FIG. 4D, two hands (465 and 475) each have a correlating a symbol (465′ and 475′) displayed on a display. Movement of the symbols 465′ and 475′ (which correlate to movement of the hands 465 and 475) will result in movement of the content in the vicinity of the symbols (e.g., triangle 4005 and circle 4004) such that their coordinates within the frame of the image 4006 stay the same whereas the image itself is stretched (the solid line objects represent content before movement of hands and the dashed line object represent the same content after movement of the hands). This way, stretching or another manipulation which is not necessarily proportional may be preformed.

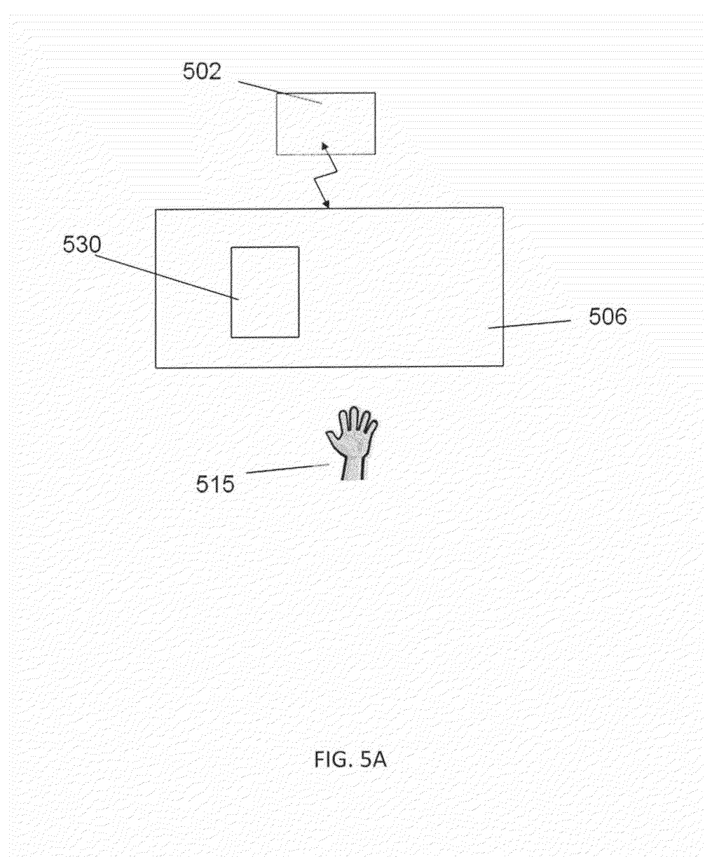

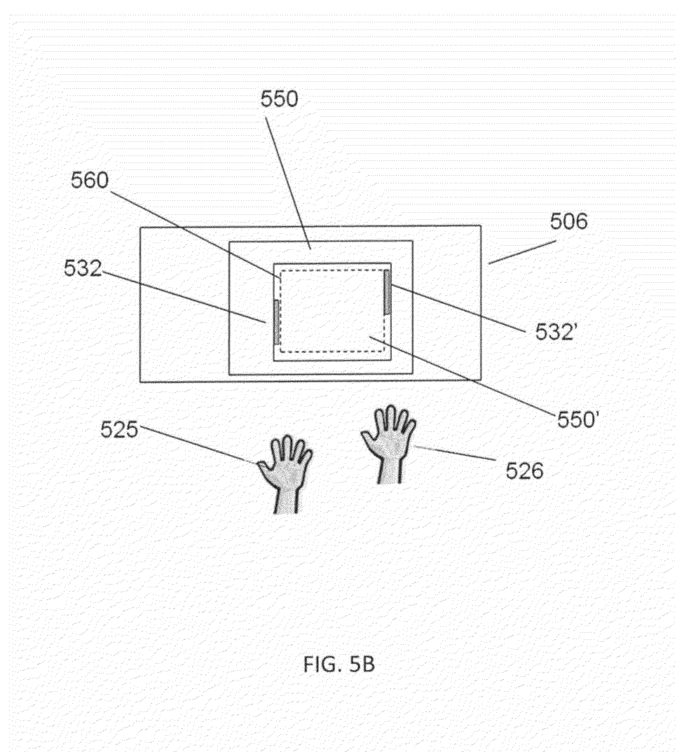

According to some embodiments, which are schematically illustrated in FIGS. 5A and 5B, there is provided a device having a processor 502 and a display 506, the display having a graphical user interface (GUI).

The processor 502 is in communication with an image sensor (such as image sensor 103) to obtain images and the processor 502, or another processing unit, can detect and track a user's hand from the images.

According to one embodiment, as in FIGS. 5A and 5B, the GUI displays a first graphical element when the processor detects a single hand 515 and the GUI comprises a second graphical element when the processor detects two hands 525 and 526, the first graphical element being different than the second graphical element.

According to one embodiment the first graphical element is a menu 530 and the second graphical element is at least one cursor 532 (or other icon or symbol). Thus, when a user is using only one hand to control a device a menu is displayed to the user. When the user adds another hand to the FOV the menu will disappear and a cursor will be displayed. The cursor (one or two cursors) may be controlled, for example, as described above.

According to one embodiment the processor 502 can detect a user's left hand and a user's right hand. The second graphical element may include a left hand cursor 532 and a right hand cursor 532′. The left hand cursor 532 may be manipulated according to the user's left hand 525 and the right hand cursor 532′ may be manipulated according to the user's right hand 526.

According to some embodiments content displayed in between the left hand cursor 532 and the right hand cursor 532′, such as an image 550 or a part of an image 550′ may be manipulated, for example, by moving, stretching, rotating or zooming only the content defined by the two cursors (532 and 532′) or by a border 560 defined by the two cursors, rather than manipulating the whole image 550.

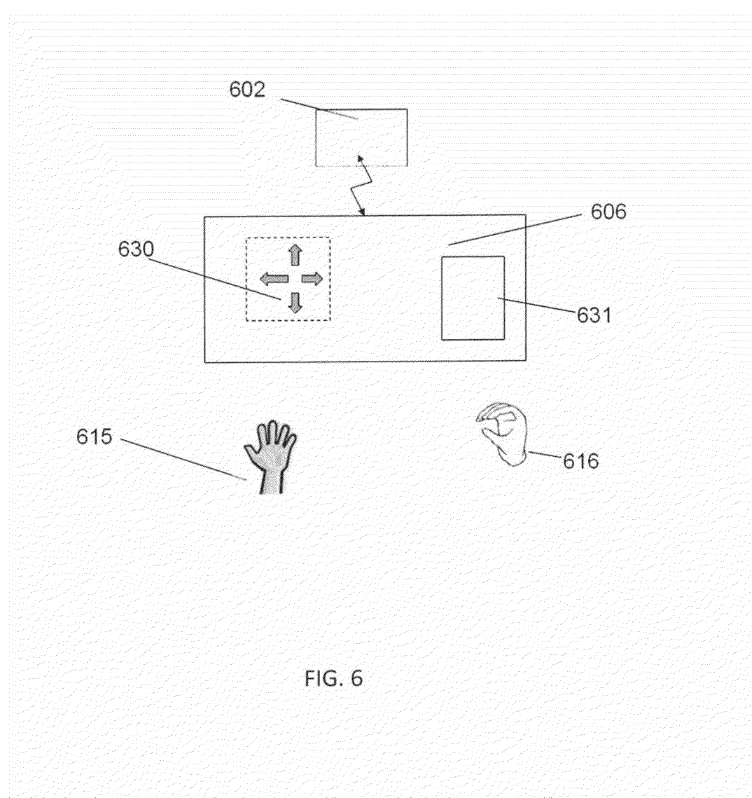

According to another embodiment, which is schematically illustrated in FIG. 6, there is provided a device having a processor 602 and a display 606, the display having a graphical user interface (GUI).

The processor 602 is in communication with an image sensor (such as image sensor 103) to obtain images and the processor 602 or another processing unit can detect and track a user's hand from the images.

According to one embodiment when a first hand posture 615 (such as a hand or palm with all fingers extended) is detected the GUI displays a first graphical element, such as a keyboard like arrows navigating symbol 630. When a second hand posture 616 (such as a hand with the tips of all fingers brought together such that the tips touch or almost touch each other) is detected the GUI displays a second graphical element, such as a menu 631.

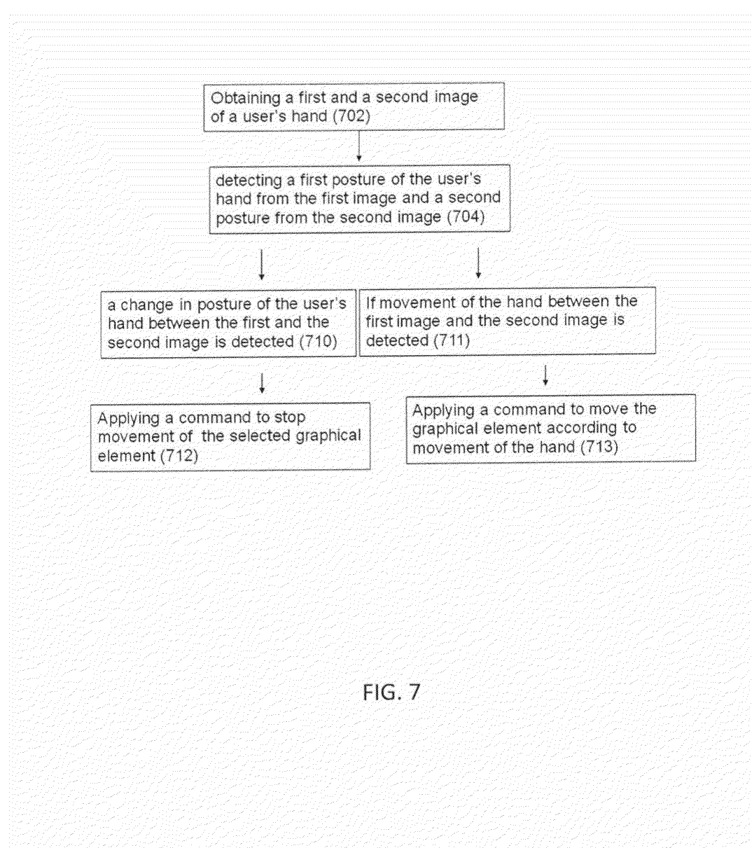

According to an embodiment of the invention there is provided a method for applying a command on a graphical element in a GUI. According to one embodiment, which is schematically illustrated in FIG. 7, the method includes obtaining a first and a second image of a user's hand (702); detecting a first posture of the user's hand from the first image and detecting a second posture of the user's hand from the second image (704); if movement of the hand between the first image and the second image is detected (711) then the graphical element is moved according to the movement of the hand (713). However, if a change in posture of the user's hand between the first and the second image is detected (710) then a command to stop movement of the selected graphical element is applied (710).

According to one embodiment the graphical element is a cursor. Thus, if a user selected a cursor by using a specific hand posture (e.g., as described above) then while keeping his/her hand in the specific posture, movement of his/her hand is tracked and the cursor is moved on a display according to movement of the user's hand. When the user changes posture of the hand, for example, the user may want to close his/her hand in a grab-like posture to perform mouse clicks (e.g., left click) or to select and/or drag objects, cursor movement due to the switching in/out of the grab-like posture needs to be avoided. Thus, terminating the command to move the cursor when a change of posture (as opposed to movement of a hand while in the same posture) is detected, ensures that in the case of movement of part of the hand during change of posture, the cursor will not be unintentionally moved.

According to one embodiment, detecting if there was a change in posture of the user's hand between the first and the second image and/or if there was movement of the hand between the first and the second image includes checking the transformation between the first and second image of the user's hand. A change of posture of the hand will typically result in relative movement of pixels in the image in a non-rigid transformation whereas movement of the whole hand (while maintaining the same posture) will typically result in a rigid transformation.

Thus, according to one embodiment, if the transformation is a non-rigid transformation then the method includes terminating a command to move the selected graphical element (e.g., cursor); and if the transformation is a rigid transformation then the method includes applying a command to move the graphical element (e.g., cursor) according to the movement of the hand.

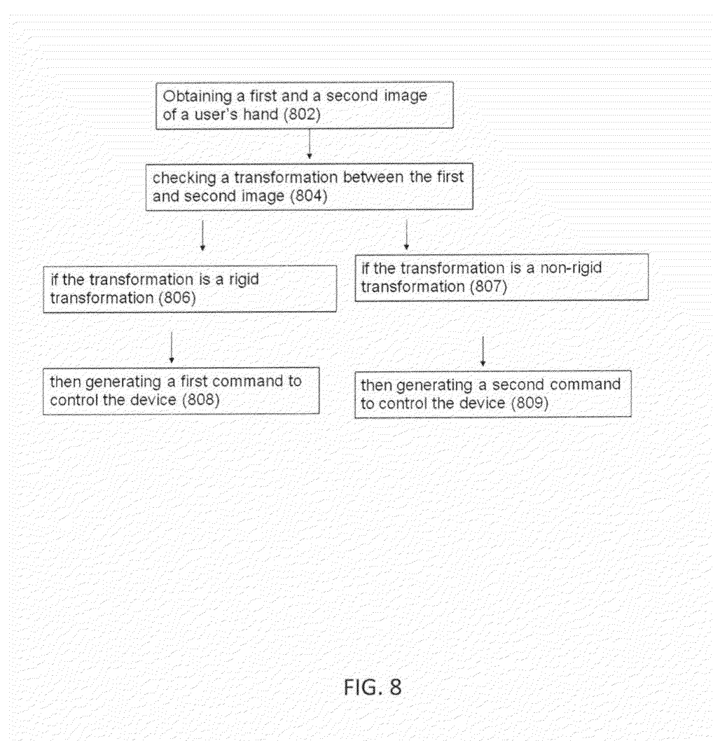

Checking the transformation between the first and second image of the user's hand can also be used beneficially, for example, to reduce computation time. For example, according to one embodiment, detecting a hand posture includes comparing the shape of a hand to a library of hand posture models. It is possible, according to embodiments of the invention, to initiate this comparison only when it is likely that a user is changing a hand posture, instead of applying the comparison continuously. This embodiment of the invention is schematically illustrated in FIG. 8.

A method for computer vision based control of a device includes obtaining a first and a second image of a user's hand (802); checking a transformation between the first and second image (804); and if the transformation is a rigid transformation (806) then generating a first command to control the device (808) and if the transformation is a non-rigid transformation (807) then generating a second command to control the device (809).

The first command may be to move a selected graphical element (e.g., cursor) according to movement of the user's hand. The second command may initiate a process of searching for a posture (e.g., by comparing to a library of models) after which the command to move the graphical element may be terminated.

1. A method for computer vision based control of displayed content, the method comprising:
obtaining an image of a field of view;
identifying within the image two hands of a user by detecting hand shapes;
detecting a first posture of at least one of the hands; and
based on the detection of the first posture and the identification of the two hands, generating a command to track movement of the two hand shapes to manipulate the displayed content based on a relative position of one hand compared to the other hand according to the movement of the user's hands.

2. The method according to claim 1, comprising:
detecting a second posture of at least one of the hands, said second posture being different than the first posture; and
disabling the command to select and manipulate the displayed content based on detection of the second posture.

3. The method according to claim 1, wherein the first posture comprises a hand with the tips of all fingers brought together such that the tips touch or almost touch each other.

4. The method according to claim 2, wherein the second posture comprises a palm with all fingers extended.

5. The method according to claim 1, wherein the manipulation of displayed content comprises zooming in and out of the content or rotating the content or a combination thereof.

6. The method according to claim 1, comprising displaying at least one icon correlating to at least one of the user's two hands and enabling to move the icon according to the hand's movement.

7. The method according to claim 2, comprising displaying a first icon when the first posture is detected and displaying a second icon when the second posture is detected.

8. The method according to claim 2, comprising:
detecting a change of posture of the hand; and
initiating a process of searching for the second posture
based on the detected change.

9. The method according to claim 8, wherein detecting a change of posture of the hand comprises checking a transformation between a first and second image and detecting the change of posture based on the transformation.

10. The method according to claim 9, wherein checking a transformation between a first and second image comprises detecting relative movement of pixels between the first and second image.
